(19) United States
(12) Patent Application Publication
(10) Pub. No.: US 2026/0292199 A1
(43) Pub. Date: Sep. 24, 2026

(54) Method and Apparatus for Multi-Source Video Encoding and Decoding

(71) Applicant: MEDIATEK INC., Hsinchu City (TW)

(72) Inventors: Tung-Hsing Wu, Hsinchu City (TW); Chi-Rung Chang, Hsinchu City (TW); Shi-Han Zhou, Hsinchu City (TW); Shih-Min Cheng, Hsinchu City (TW)

(73) Assignee: MEDIATEK INC., Hsinchu City (TW)

(21) Appl. No.: 19/554,601

(22) Filed: Mar. 2, 2026

Related U.S. Application Data
(60) Provisional application No. 63/776,348, filed on Mar. 24, 2025.

(51) Int. Cl. H04N 19/147; H04N 19/124; H04N 19/196; H04N 19/70

(52) U.S. Cl. CPC H04N 19/147; H04N 19/124; H04N 19/196; H04N 19/70

(57) ABSTRACT

A method for video encoding includes receiving a first source data and a second source data for a same packed source data. A packed source picture is generated by arranging a first frame corresponding to the first source data into a first region of the packed source picture and a second frame corresponding to the second source data into a second region of the packed source picture. A distortion control process uses a first distortion control policy for the first region and a second distortion control policy for the second region. The packed source picture is encoded based on the distortion control process. Additionally, a video decoding method includes receiving a video bitstream corresponding to the packed source picture, obtaining the first frame from the first region and the second frame from the second region, and processing the first frame using the second frame to generate an output video frame.

### CROSS REFERENCE TO RELATED APPLICATIONS

This application claims the benefit of U.S. Provisional Application No. 63/776,348, filed on Mar 24th, 2025. The content of the application is incorporated herein by reference.

### BACKGROUND

### 1. Field of the Invention

The invention relates to video coding technologies, and more particularly to methods for multi-source encoding and decoding.

### 2. Description of the Prior Art

With advances in camera technology—especially in mobile devices like smartphones—there is growing demand for advanced video capture modes such as “cinematic mode” or “portrait video.” In these modes, complicated information may be required. Conventional camera systems compress source data based on a multitude of competing factors. Applying a uniform bitrate or compression policy across such diverse data types can therefore lead to suboptimal results, either by over-distorting the auxiliary side data or by wasting encoded bits on the main video. Accordingly, there is a need for a method that enables lower-energy, high-quality multi-stream video compression by efficiently handling multiple data types within a single encoding process.

### SUMMARY

An embodiment provides a method of video encoding in a video system. The method comprises receiving a first source data and a second source data for a same packed source data. A packed source picture is generated by arranging a first frame corresponding to the first source data into a first region of the packed source picture and a second frame corresponding to the second source data into a second region of the packed source picture. A distortion control process is applied to the packed source picture, utilizing a first distortion control policy for the first region and a second distortion control policy for the second region. The packed source picture is subsequently encoded based on the distortion control process.

In some aspects, the first distortion control policy determines a quantization parameter for the first region according to a bit-rate setting of a rate control process. The second distortion control policy may apply a predetermined quantization parameter setting to the second region. This predetermined quantization parameter setting may comprise an absolute quantization parameter value, a fixed offset value relative to a quantization parameter of the first region, or a quantization parameter map indicating quantization parameters for a plurality of coding units within the second region.

In some aspects, the method further comprises converting a color format of at least one of the first source data or the second source data to a uniform color format prior to generating the packed source picture, wherein the packed source picture is generated in the uniform color format. A boundary between the first region and the second region within the packed source picture may be aligned with a boundary of a coding block unit used in encoding the packed source picture.

In some aspects, the method further comprises receiving a third source data for the same packed source data and arranging a third frame corresponding to the third source data into a third region of the packed source picture, wherein the distortion control process further uses a third distortion control policy for the third region. The first source data may comprise video content, while the second source data may comprise depth information or segmentation information associated with the video content. Additionally, packed information may be encoded into the video bitstream as supplementary information, indicating a resolution and a color format for each of the first source data and the second source data.

An embodiment provides a method of video decoding in a video system. The method comprises receiving a video bitstream corresponding to a packed source picture. The video bitstream is decoded to obtain the packed source picture, wherein the packed source picture comprises a first region including a first frame and a second region including a second frame. The method further comprises obtaining the first frame from the first region and the second frame from the second region. The first frame is processed using the second frame to generate an output video frame.

In some aspects, the method further comprises receiving packed information associated with the video bitstream which indicates a resolution and a location of the first frame and the second frame within the packed source picture, and determining the first region and the second region based on this packed information. This packed information may be decoded from a Supplemental Enhancement Information (SEI) message within the video bitstream.

In some aspects, the first frame comprises main video content, and the second frame comprises depth information or segmentation information associated with the main video content. Processing the first frame using the second frame may comprise applying a visual effect to the main video content based on the depth information or the segmentation information to generate the output video frame. The visual effect may comprise a depth-of-field effect or a skin enhancement effect.

In some aspects, the packed source picture is in a uniform color format comprising a plurality of color channels, and the second region of the packed source picture comprises padding values in specific color channels that are present in the uniform color format but absent in an original source format of the second frame. A boundary between the first region and the second region may be aligned with a boundary of a coding block unit of the packed source picture. Furthermore, the packed source picture may comprise a third region having a third frame, and processing the first frame may further comprise using the third frame to generate the output video frame.

An embodiment provides an apparatus for video encoding, comprising one or more processors configured to receive a first source data and a second source data for a same packed source data. The processors are configured to generate a packed source picture by arranging a first frame corresponding to the first source data into a first region of the packed source picture and a second frame corresponding to the second source data into a second region of the packed source picture. The processors apply a distortion control process to the packed source picture, wherein the distortion control process uses a first distortion control policy for the first region and a second distortion control policy for the second region. The processors then encode the packed source picture into a video bitstream based on the distortion control process.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a schematic block diagram illustrating a video processing system according to an embodiment.

FIG. 2 depicts an example of a frame structure for packed source data according to an embodiment.

FIG. 3 depicts another example of a frame packing arrangement for packed source data according to an embodiment.

FIG. 4 depicts another example of a frame packing arrangement for packed source data according to an embodiment.

FIG. 5 depicts a schematic block diagram illustrating a video processing system according to another embodiment.

FIG. 6 depicts an example of a frame structure for packed source data with additional source data according to an embodiment.

FIG. 7 depicts another example of a frame structure for packed source data according to an embodiment.

FIG. 8 depicts another example of a frame structure for packed source data according to an embodiment.

FIG. 9 depicts a flow diagram of a method for video encoding implementing frame packing and distortion control according to an embodiment.

FIG. 10 depicts a schematic block diagram illustrating a video processing system for decoding a video bitstream with unpacking according to an embodiment.

FIG. 11 depicts a flow diagram of a method for video decoding according to an embodiment.

FIG. 12 depicts a block diagram illustrating a video encoder according to an embodiment.

FIG. 13 depicts a block diagram illustrating a video decoder according to an embodiment.

### DETAILED DESCRIPTION

The following description is presented to enable any person skilled in the art to make and use the disclosed embodiments. The various embodiments of the present invention may be implemented in the context of video coding systems and standards. While the specific methods for frame packing and distortion control described herein may operate as a pre-processing or high-level syntax layer (e.g., using Supplemental Enhancement Information or SEI messages) independent of a specific standard, the underlying video encoding and decoding processes may be compliant with various video coding standards. These standards include, but are not limited to, H.264/AVC (Advanced Video Coding), H.265/HEVC (High Efficiency Video Coding), H.266/VVC (Versatile Video Coding), and AV1 (AOMedia Video 1). Accordingly, terms may be used throughout this disclosure, such as coding tree unit (CTU), macroblock (MB), superblock, coding unit (CU), and quantization parameter (QP), should be understood broadly to encompass corresponding structures and parameters defined within these or other video coding specifications.

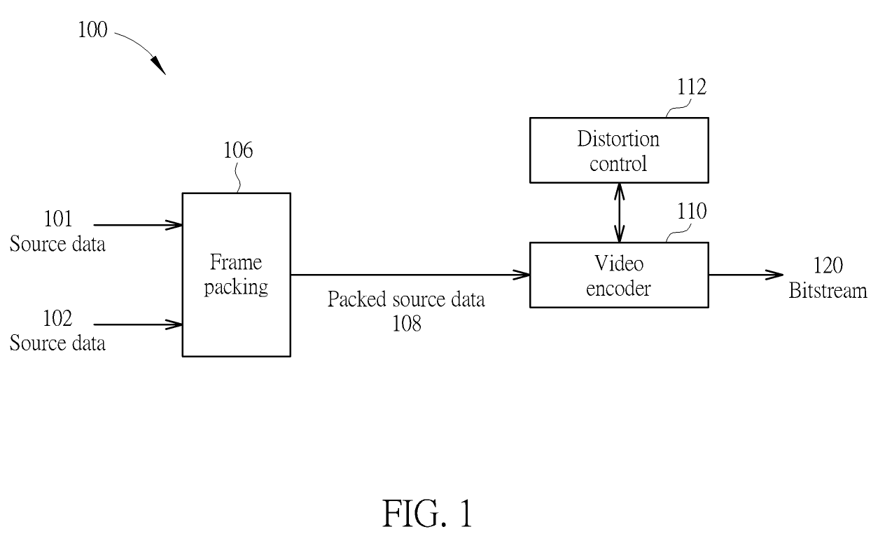

FIG. 1 depicts a schematic block diagram illustrating a video processing system 100 according to an embodiment of the present disclosure. The video processing system 100 is configured to encode multiple source data streams for a same packed source data (for example, such same packed source data is associated with a same scene) and generate a single compressed video bitstream 120.

As shown in FIG. 1, the system receives first source data 101 and second source data 102. The first source data 101 may represent main video content (e.g., a "Record" stream), which typically requires high resolution and may have a specific color format, such as YUV 4:2:0 or YUV 4:2:2, and a bit-depth of 8-bit or 10-bit. The second source data 102 represents auxiliary information or "side information" associated with the first source data 101. Examples of the second source data 102 include a depth map, a skin tone map, or other segmentation information. The second source data 102 may have a different format compared to the first source data 101, such as a Y-only format (monochrome) and a lower bit-depth (e.g., 8-bit). Although only two source data inputs are illustrated, the video processing system 100 may receive and process more than two source data inputs (e.g., an n-th source data).

The frame packing unit 106 receives the first source data 101 and the second source data 102 and performs a frame packing process. In some embodiments, the frame packing unit 106 converts the color format of the incoming source data (101, 102) to a uniform color format (e.g., 10-bit YUV 4:2:0) to ensure compatibility within a single frame structure. The frame packing unit 106 arranges a frame corresponding to the first source data 101 and a frame corresponding to the second source data 102 into distinct regions of a single frame, thereby generating the packed source data 108. The arrangement of these regions generally ensures that the boundaries between the source data align with the coding block units (e.g., CTU or MB) used by the subsequent compression stage.

In some embodiments, the packed source data is generated with at least a top-left boundary alignment among a plurality of packed regions corresponding to respective source data. In particular, a top-left corner of a region associated with the first source data is aligned with a top-left corner of a region associated with another source data (or with a top-left corner of the packed source data frame).

In some embodiments, when a resolution of at least one source data is not an integer multiple of a coding tree unit (CTU) size used by the video encoder, the frame packing further comprises performing at least one of padding and cropping such that boundaries of the corresponding packed region satisfy a CTU-aligned boundary condition. The packed information further indicates alignment parameters including at least one of region offsets, region dimensions, padding sizes, and cropping sizes.

Such alignment reduces cross-region interference at CTU boundaries and enables region-specific distortion control to be applied on a CTU basis when source resolutions are not CTU-multiples.

The packed source data 108 is then transmitted to a video encoder 110. The video encoder 110 is responsible for encoding the packed source data 108 into the video bitstream 120 using a video coding standard (e.g., H.264, H.265, or AV1).

The video processing system 100 includes a distortion control unit 112 coupled to the video encoder 110. The distortion control unit 112 is configured to apply a distortion control process utilizing at least two different policies to the packed source data 108 during compression. For example, the distortion control unit 112 may instruct the video encoder 110 to apply a first distortion control policy (e.g., a Rate Control process based on a target bit-rate) to the region containing the first source data 101. Simultaneously, the distortion control unit 112 instructs the video encoder 110 to apply a second distortion control policy (e.g., a predetermined quantization parameter setting, such as a fixed QP or an offset QP) to the region containing the second source data 102.

The resulting video bitstream 120 includes the encoded packed frame and may optionally include packed information (e.g., encoded as an SEI message) describing the layout, resolution, and original formats of the source data 101 and 102, allowing a decoder to correctly separate and process the regions.

In some embodiments, at least a portion of the frame packing process performed by the frame packing unit 106 is implemented as an internal function of the video encoder 110. For example, the video encoder 110 may include a frame packing function configured to arrange corresponding frames of the first source data 101 and the second source data 102 into respective regions of the packed source data 108 prior to encoding.

In some embodiments, at least a portion of the distortion control process performed by the distortion control unit 112 is implemented as an internal function of the video encoder 110. For example, the video encoder 110 may include a distortion control function configured to apply the first distortion control policy and the second distortion control policy to respective regions of the packed source data 108 during encoding.

In some embodiments, both the frame packing process and the distortion control process are implemented within the video encoder 110, such that the video encoder 110 performs generation of the packed source data 108 and applies region-specific distortion control during encoding.

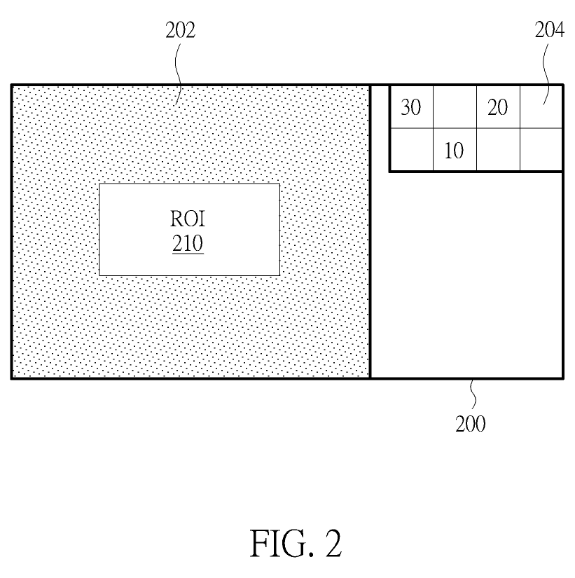

FIG. 2 depicts an example of a frame structure for the packed source data according to an embodiment of the present disclosure. As shown in FIG. 2, the frame of the packed source data 200 can be a single image frame that aggregates multiple distinct source data inputs. The packed frame may be spatially partitioned into separate regions to accommodate these inputs.

A frame of the first source data 202 occupies a first region of the packed frame. Within this first region, a region of interest (ROI) 210 may be defined. The ROI 210 can represent a specific area within the first source data 202 that is designated for higher quality or prioritized encoding during the compression process. For instance, a first distortion control policy, such as a rate control algorithm, can regulate the quantization parameters of the coding units within the first source data 202, and may assign lower quantization parameters (higher quality) to the ROI 210 compared to other areas of the first source data 202.

A frame of the second source data 204 occupies a second region of the packed frame (illustrated on the top right). This second region may correspond to auxiliary data, such as depth map or segmentation information. The frame of the second source data 204 is illustrated as being divided into a plurality of coding blocks (e.g., macroblocks, coding tree units (CTUs), or superblocks).

Numerical values (e.g., 30, 20, 10) are depicted within these coding blocks. These values can represent a quantization parameter (QP) map applied as a second distortion control policy. Unlike the dynamic rate control that may be used for the first source data 202, the second source data 204 can utilize a predetermined quantization parameter setting defined by this map, where specific coding units are encoded with fixed QP values (e.g., a QP of 10 for high importance, a QP of 30 for low importance). This arrangement allows for precise, localized control over the distortion of the side information. Furthermore, the boundary separating the frame of the first source data 202 and the frame of the second source data 204 may be aligned with the boundaries of the coding blocks (e.g., multiples of 32 pixels for a 32×32 CTU) to make sure that no single coding unit overlaps both data types, facilitating efficient independent distortion control.

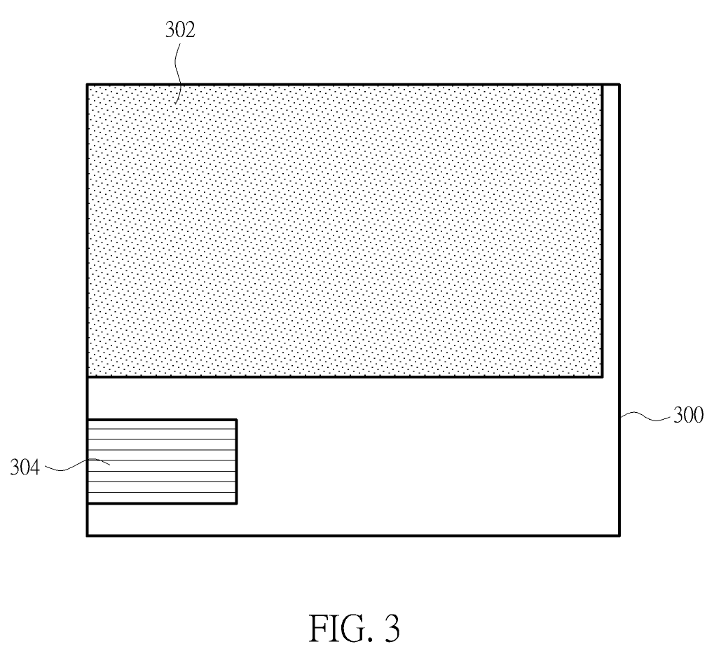

FIG. 3 depicts another example of a frame packing arrangement for the packed source data according to an embodiment of the present disclosure. This embodiment demonstrates an alternative geometric layout for combining multiple source data streams into a single frame, which may be selected based on resolution constraints or coding efficiency requirements.

As shown in FIG. 3, the frame of the packed source data 300 is organized to include a frame of the first source data 302 and a frame of the second source data 304. In this specific configuration, the first source data 302 (e.g., the main video content) is positioned in the upper portion of the packed frame. The second source data 304 (e.g., auxiliary side information) is arranged in a region vertically below the first source data 302.

This vertical arrangement contrasts with the horizontal (side-by-side) arrangement depicted in FIG. 2. The selection of this vertical packing format may be driven by the aspect ratio of the source content or the maximum resolution dimensions supported by a target video level (e.g., H.264/H.265 Levels). For instance, if extending the width of the packed frame would cause the video to exceed a standard width limit (e.g., 1920 pixels or 3840 pixels), placing the second source data 304 below the first source data 302 allows the system to increase the frame height instead, keeping the total pixel count or dimensions within the allowable limits of the hardware or standard profile.

Similar to the previous embodiment, the boundary between the first source data 302 and the second source data 304 is preferably aligned with the boundaries of the coding block units (e.g., CTUs) to ensure that the distortion control process can be applied independently to each region without boundary artifacts. The remaining area within the packed source data 300 that is not occupied by the first or second source data may be filled with padding data.

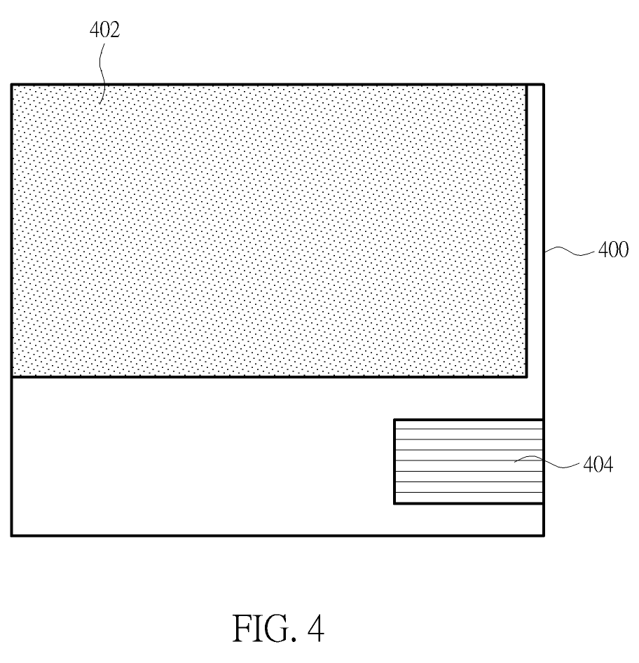

FIG. 4 depicts another example of a frame packing arrangement for the packed source data according to an embodiment of the present disclosure. As shown in FIG. 4, the frame of the packed source data 400 may organize the distinct source inputs in a diagonal or corner-based layout.

In this configuration, a frame of the first source data 402 is placed in a first region of the packed frame at the top-left corner. A frame of the second source data 404 is placed in a second region at the bottom-right corner. With this corner-based placement, the first source data 402 and the second source data 404 are separated both horizontally and vertically by unused areas, which may be filled with padding values.

This layout may be used to satisfy particular resolution requirements and/or to increase spatial separation between the main video content and side information during encoding. As in the previous examples, the boundaries of the first and second regions within the packed source data 400 may be aligned with coding block unit boundaries to support efficient distortion control.

Unlike the embodiments of FIG. 2 and FIG. 3, the embodiment of FIG. 4 employs a diagonal (corner-based) packing arrangement rather than a contiguous horizontal or vertical layout. For instance, FIG. 2 depicts a horizontal extension in which the frame of the second source data 204 is positioned adjacent to the right side of the frame of the first source data 202, increasing the packed frame width. FIG. 3 depicts a vertical extension in which the frame of the second source data 304 is positioned adjacent to the bottom side of the frame of the first source data 302, increasing the packed frame height. In both FIG. 2 and FIG. 3, the active data regions share a common boundary.

By contrast, FIG. 4 illustrates a configuration in which the frame of the second source data 404 is spatially separated from the frame of the first source data 402. As shown, the first source data 402 may occupy a first corner (e.g., top-left) while the second source data 404 occupies an opposing corner (e.g., bottom-right), such that the regions do not contact each other. As a result, padding areas exist between the regions along both horizontal and vertical directions. This arrangement may be selected to achieve a desired overall frame geometry or aspect ratio, including geometries that differ from the elongated rectangular shapes produced by the arrangements of FIG. 2 and FIG. 3.

In certain implementations, the video processing system 100 (referring back to FIG. 1) can receive and process multiple source-data streams that may differ materially in their technical specifications. For example, first source data (e.g., a main video recording) may use a higher-fidelity color format such as YUV 4:2:2 with 10-bit color depth, while second source data (e.g., depth maps or segmentation maps) may use a lower-fidelity format such as YUV 4:2:0 with 8-bit color depth. To accommodate these differences, the system performs a format-alignment step in which each source is converted to a uniform color format for subsequent processing (for example, converting the 8-bit source to a 10-bit container format).

After the color formats are aligned, the video processing system 100 generates packed source data by arranging corresponding frame data from the first and second sources into a single composite frame (i.e., frame of the packed source data). The composite frame conforms to the selected uniform color format, enabling it to be handled by a standard video codec pipeline. To ensure the decoder can correctly interpret and reconstruct the individual sources from the composite frame, the video processing system also generates packed information describing the organization of the packed frame. This packed information can include, for example, the particular frame-packing format used (including arrangements illustrated in FIGS. 2, 3, and 4) and the original resolution and color format of each source-data stream. In some implementations, this metadata is carried in the resulting video bitstream as supplemental information, such as within a Supplemental Enhancement Information (SEI) message.

The video processing system 100 then can compress the packed source data into a video bitstream. The compression implements a distortion-control process that applies at least two distinct distortion-control policies based on the packed information. In general, the distortion-control process may operate as part of rate control, regulating the quantization parameter (QP) used for coding units within the packed frame.

Policy application is region-specific. A first distortion-control policy is applied to coding units corresponding to the first source data, where the QP may be determined dynamically in accordance with a first bitrate setting (for example, to meet a target bitrate for the main video). A second distortion-control policy is applied to coding units corresponding to the second source data. Depending on implementation, this second policy may determine QP using a distinct second bitrate setting, or it may apply a predetermined QP setting that prioritizes consistent fidelity over dynamic bitrate targeting.

When the second policy uses a predetermined quantization approach, it may be implemented in several ways. In one example, the coding units are encoded using a fixed QP corresponding to a specified absolute value. In another example, the coding units are encoded using a QP derived from an offset relative to the QP applied elsewhere in the packed frame (for instance, ensuring the second-source region is encoded at a QP that is lower than the main-video region by a fixed amount). In yet another example, the system applies a quantization-parameter map that specifies QP values for multiple coding units associated with the packed source picture, enabling fine-grained control over selected blocks within the second-source region.

Although the foregoing description focuses on packing two source-data streams, the techniques are not limited to two inputs. In various embodiments, more than two source-data streams can be packed into a single frame and encoded using the same general approach, with packed information and region-specific distortion-control policies extending accordingly.

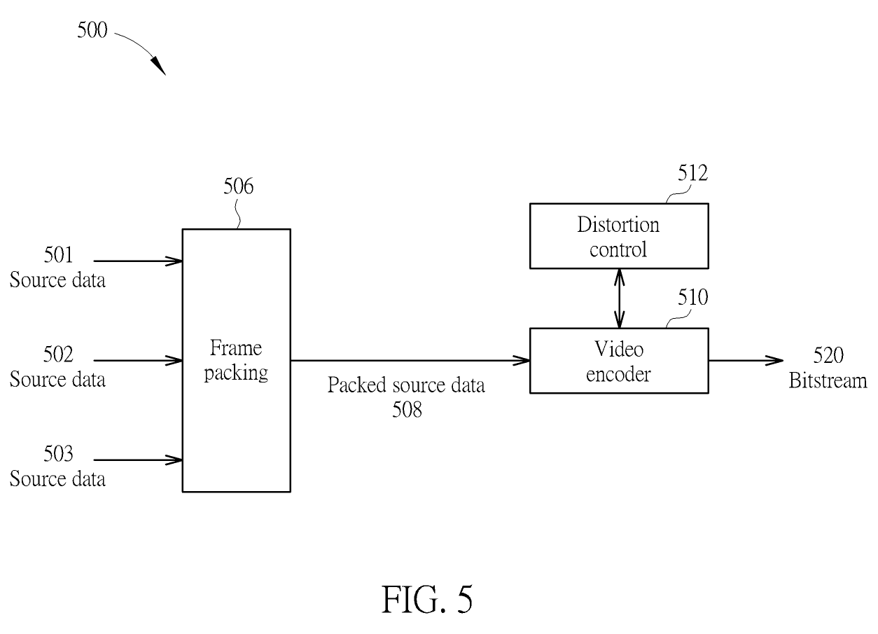

FIG. 5 depicts a schematic block diagram illustrating a video processing system 500 according to another embodiment of the present disclosure. The video processing system 500 is configured to encode three distinct source data inputs. As illustrated, the video processing system 500 receive a first source data 501, a second source data 502, and a third source data 503. The first source data 501 typically represents the main video content utilizing a specific format, such as a first color format (e.g., YUV 4:2:0, 10-bit). The second source data 502 and the third source data 503 correspond to auxiliary side information for the same packed source data (for example, associated with the same scene) as the first source data 501; for example, the second source data 502 may be a depth map utilizing a second color format (e.g., YUV 4:2:0, 8-bit), while the third source data 503 may be segmentation information utilizing a third color format (e.g., YUV 4:0:0, 10-bit).

These three inputs are received by a frame packing unit 506 within the video processing system 500, which performs the necessary processing to combine them. The processes may involve converting the color formats of the varying source data to a uniform color format (e.g., converting all inputs to match 10-bit YUV 4:2:0) to ensure compatibility. The frame packing unit 506 then arranges the frames corresponding to the first, second, and third source data into distinct regions of a single composite frame, thereby generating the packed source data 508. This packing process organizes the data into a single geometric structure, effectively aggregating multiple streams into one entity for efficient processing.

The packed source data 508 is subsequently transmitted to a video encoder 510, which encodes the data into a single video bitstream 520. To manage the varying quality requirements of the different data types, the video processing system 500 utilizes a distortion control unit 512 coupled to the compression unit. The distortion control unit 512 applies a multi-policy distortion control process to the packed source data 508, utilizing up to three different policies for the three distinct regions. For instance, a first distortion control policy may be applied to the region of the first source data 501, determining quantization parameters based on a first bit-rate setting. A second distortion control policy may be applied to the region of the second source data 502, determining quantization parameters based on a separate second bit-rate setting. Additionally, a third distortion control policy may be applied to the region of the third source data 503, applying a predetermined quantization parameter setting, such as a fixed absolute value, an offset value, or a quantization parameter map. This configuration enables the video processing system 500 to efficiently compress multiple auxiliary streams alongside the main video into a bitstream 520 while independently optimizing the fidelity of each component.

In some embodiments, at least one of the frame packing process for generating the packed source data 508 or the multi-policy distortion control process is implemented as an internal function of the video encoder 510. For example, the video encoder 510 may include a packing function to arrange frames of the first source data 501, the second source data 502, and the third source data 503 into corresponding regions of the packed source data 508, and/or include a distortion control function to apply respective distortion control policies to the corresponding regions during encoding.

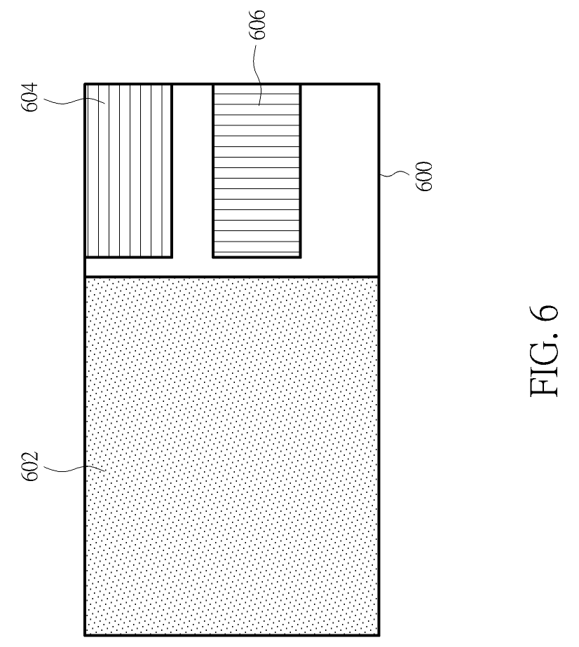

FIG. 6 depicts an example of a frame structure for the packed source data according to an embodiment of the present disclosure, which expands upon the configuration shown in FIG. 2 by incorporating additional source data.

As shown in FIG. 6, the frame of the packed source data 600 may be partitioned to accommodate three distinct inputs: a frame of the first source data 602, a frame of the second source data 604, and a frame of the third source data 606. In this arrangement, the first source data 602 can be positioned in a primary region (e.g., the left side), while the second source data 604 and the third source data 606 are stacked vertically in a secondary column (e.g., on the right side) to optimize the usage of the frame's geometric area.

This layout allows the video processing system to handle diverse data types simultaneously. For instance, the first source data 602 may represent the main video content (e.g., utilizing a YUV 4:2:0, 10-bit format), while the second source data 604 may represent depth information (e.g., utilizing a YUV 4:2:0, 8-bit format). The third source data 606 can represent distinct segmentation information, such as a skin-tone map, which might originally utilize a different color format (e.g., YUV 4:0:0) before being packed.

A distortion control process can be applied to each region independently to maximize efficiency. A first distortion control policy may regulate the first source data 602 according to a first bit-rate setting. A second distortion control policy may be applied to the second source data 604, potentially utilizing a second, independent bit-rate setting. Furthermore, a third distortion control policy can be applied to the third source data 606. This third policy may implement a predetermined quantization parameter setting (e.g., an absolute QP value, an offset value relative to the first region, or a QP map) to provide specific fidelity levels for the segmentation data without being constrained by the bitrate fluctuations of the main video. As in previous embodiments, the boundaries between the first, second, and third regions may be aligned with the coding block units of the packed frame.

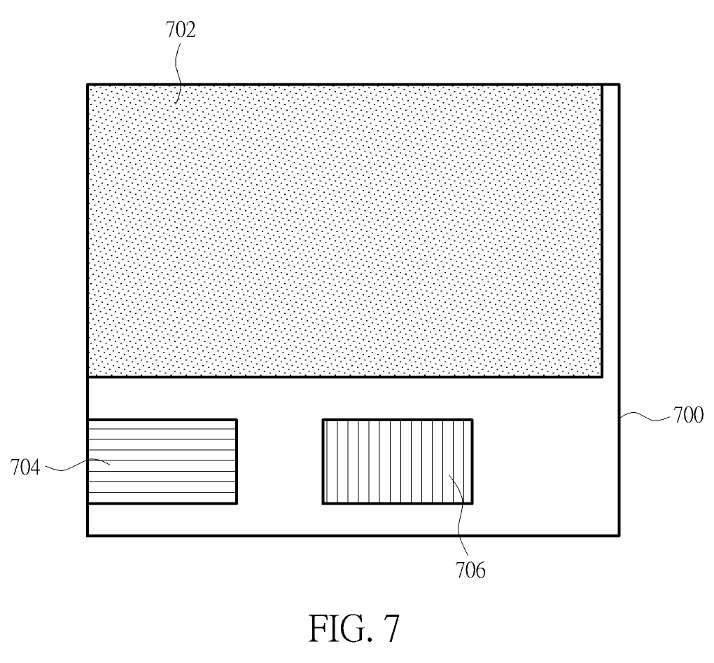

FIG. 7 depicts another example of a frame structure for the packed source data according to an embodiment of the present disclosure, which expands upon the configuration shown in FIG. 3 by incorporating additional source data. This embodiment illustrates an alternative geometric layout for aggregating three distinct source data inputs, which may be selected based on the specific resolution or aspect ratio constraints of the target video standard.

As shown in FIG. 7, the frame of the packed source data 700 can be organized into upper and lower sections. A frame of the first source data 702, corresponding to the main video content, may occupy a first region located in the upper portion of the packed frame.

In a region vertically below the first source data 702, the auxiliary information is arranged. A frame of the second source data 704 (e.g., a depth map) and a frame of the third source data 706 (e.g., a segmentation map) can be positioned side-by-side in a horizontal arrangement. This configuration contrasts with the side-stacking arrangement of FIG. 6 and may be particularly advantageous when the width of the packed frame is constrained by a maximum resolution level, necessitating a vertical expansion of the frame geometry instead.

Consistent with previous embodiments, a distortion control process can be applied independently to each defined region. The first source data 702 may be encoded using a first distortion control policy (e.g., rate control), while the second source data 704 and the third source data 706 can be encoded utilizing distinct predetermined quantization parameter settings (e.g., fixed QP values or offsets) to ensure the fidelity of the side information. Additionally, the boundaries separating the first source data 702, the second source data 704, and the third source data 706 may be aligned with the coding block units of the packed frame to facilitate efficient compression processing.

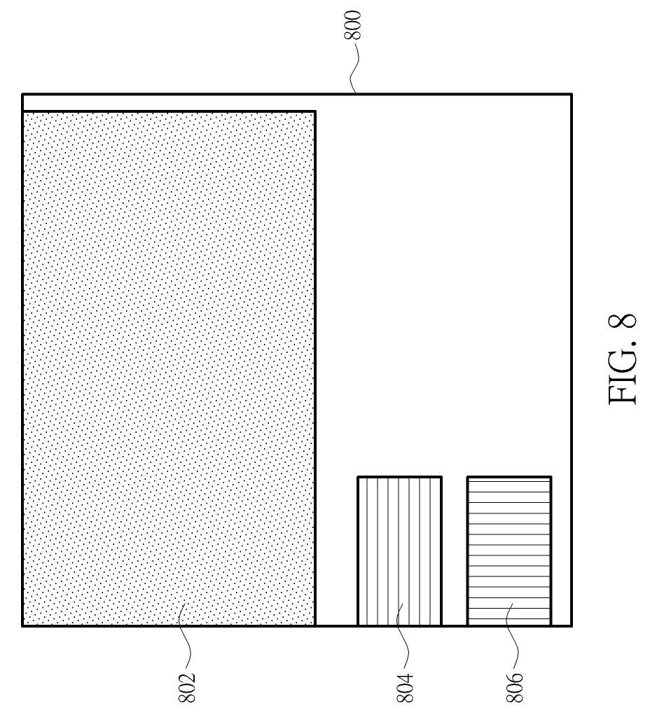

FIG. 8 depicts another example of a frame structure for the packed source data according to an embodiment of the present disclosure. This embodiment illustrates a vertical stacking configuration for the auxiliary data, which offers a different geometric aspect ratio compared to the side-by-side arrangement of FIG. 7.

As shown in FIG. 8, the frame of the packed source data 800 may be partitioned into distinct regions to accommodate three source inputs. A frame of the first source data 802, representing the main video content, can occupy a primary region located in the upper portion of the packed frame.

In the area vertically below the first source data 802, the auxiliary information is arranged in a vertical column. A frame of the second source data 804 (e.g., a depth map) may be positioned below the first source data 802. Immediately beneath the second source data 804, a frame of the third source data 806 (e.g., segmentation information) can be arranged in a third region.

This configuration groups the auxiliary data (804, 806) into a single vertical strip below the main content. This layout allows for the application of region-specific coding parameters. The first source data 802 typically utilizes a first distortion control policy (e.g., dynamic rate control). Meanwhile, the second source data 804 and the third source data 806 can be encoded utilizing distinct predetermined quantization parameter settings (e.g., specific absolute QP values or offsets relative to the first region) to maintaining the precise fidelity required for post-processing applications. As with previous embodiments, the boundaries separating these regions may be aligned with the coding block units of the packed frame to ensure efficient encoding.

In certain implementations, the video processing system 500 (referring back to FIG. 5) can receive and process multiple source-data streams that may differ materially in their technical specifications. For example, the first source data (e.g., main video content) may utilize a high-fidelity first color format, such as YUV 4:2:0 with a 10-bit color depth. The second source data (e.g., a depth map) may use a different second color format, such as YUV 4:2:0 with an 8-bit color depth. Furthermore, a third source data (e.g., segmentation data) may utilize a distinct third color format, such as YUV 4:0:0 (monochrome) with a 10-bit color depth. To unify these inputs for processing, the video processing system 500 performs a conversion wherein the color format of each source data is converted to a uniform color format (e.g., converting all streams to match a 10-bit YUV 4:2:0 container).

Following this format alignment, the system generates packed source data. This involves arranging the corresponding frame data from the first, second and third source data into a single frame structure, wherein the color format of this combined frame adheres to the selected uniform color format. To ensure the decoder can properly interpret this composite image, the system generates packed information. This information explicitly describes the organization of the packed source data, comprising the specific frame packing format used (examples of which are illustrated in FIGS. 6, 7, and 8), as well as the original resolution and color format of each individual source data stream. This packed information may be encoded into the video bit-stream as supplementary information, for example, within a Supplemental Enhancement Information (SEI) message.

Once packed, the system compresses the packed source data to generate the video bit-stream. The application of a distortion control process implements at least two (or three) distinct distortion control policies based on the packed information. This process generally functions as a rate control mechanism, regulating the quantization parameter (QP) of the coding units within the frame during compression.

The application of these policies is region-specific to optimize quality for different data types. For example, a first distortion control policy is applied to the frame data of the first source data, wherein the quantization parameter is determined according to a first bit-rate setting of the video compression process. A second distortion control policy is applied to the frame data of the second source data, wherein the quantization parameter is determined according to a distinct second bit-rate setting. Furthermore, a third distortion control policy is applied to the frame data of the third source data, utilizing a predetermined quantization parameter setting.

The predetermined quantization parameter setting utilized for the third source data (or other applicable auxiliary regions) may be implemented via several specific mechanisms. In one implementation, the setting relies on an absolute value, wherein the coding unit is encoded utilizing a fixed quantization parameter related to a specific absolute value. Alternatively, the setting may utilize an offset value, wherein the coding unit is encoded utilizing a quantization parameter calculated based on an offset relative to the quantization parameter applied to other coding units within the packed frame. In another implementation, a quantization parameter map is employed, which comprises specific quantization parameter information for a plurality of coding units related to the frame of the packed source data, thereby allowing for granular control over specific blocks within the region.

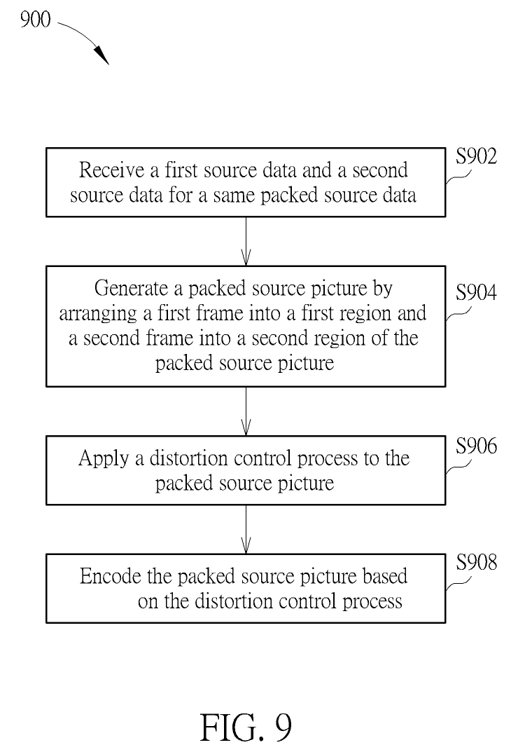

FIG. 9 depicts a flow diagram of method 900 for video encoding in a video system that implements frame packing and distortion control for efficient multi-source video compression. The method 900 may be implemented by video processing system 100 shown in FIG. 1. Also, the method 900 enables the compression of multiple video sources for the same packed source data (for example, the packed source data associated with the same scene) into a single video bitstream while maintaining optimal quality for each source through differentiated distortion control policies. This approach addresses the growing need in video compression to convey multiple types of side information within a video scenario, such as depth of field, video content segmentation, and other additional source data, while avoiding the higher power consumption and quality issues associated with compressing these sources separately. The method 900 includes the following steps:

S902: Receive a first source data and a second source data for a same packed source data;

S904: Generate a packed source picture by arranging a first frame corresponding to the first source data into a first region of the packed source picture and a second frame corresponding to the second source data into a second region of the packed source picture;

S906: Apply a distortion control process to the packed source picture; and

S908: Encode the packed source picture based on the distortion control process.

In step S902, the video encoding system 100 receives at least two distinct source data streams for the same packed source data (for example, that capture the same scene from different perspectives or represent different types of information about the scene.) The source data may include main video content (first source data) captured in YUV 4:2:0 format at either 8-bit or 10-bit depth, depth information represented as a depth map in Y-only format at 8-bit depth, auxiliary information such as segmentation maps or skin tone maps also in Y-only format, or secondary video streams such as thumbnails or preview feeds in YUV 4:2:0 8-bit format. These source data streams are received by video processing system 100 and prepared for subsequent processing by frame packing unit 106.

Each source data stream may possess different characteristics that affect how it should be processed and compressed. These characteristics include varying color formats such as YUV 4:2:2, YUV 4:2:0 or YUV 4:0:0, different bit depths ranging from 8-bit to 10-bit representation, different spatial resolutions, and different content characteristics that dictate varying quality requirements. For instance, the main video content (first source data) shown in FIGS. 2-4 typically requires higher quality preservation than auxiliary depth maps or segmentation information (second source data). Video processing system 100 analyzes these characteristics to determine the appropriate uniform color format for subsequent packing operations.

The association with the "same scene" means that all source data streams are temporally synchronized and represent the same spatial or temporal content, even though they may convey different types of information. For example, while one stream provides color information about a scene, another may provide depth information, and yet another may provide object segmentation data, but all three describe the same moment in time and the same physical space. This temporal alignment is maintained throughout the processing pipeline of video processing system 100.

In step S904, frame packing unit 106 creates a unified frame structure that combines multiple source frames into a single composite frame through a process known as frame packing. Before the actual packing can occur, each source data stream undergoes color format conversion to ensure compatibility. For example, if the first source data arrives in YUV 4:2:2 10-bit format while the second source data uses YUV 4:2:0 8-bit format, both streams are converted by frame packing unit 106 to a common uniform format, such as YUV 4:2:2 10-bit, to ensure optimal quality preservation and processing compatibility throughout the compression pipeline. This conversion process is performed prior to the spatial arrangement of the frames.

Frame packing unit 106 spatially organizes the corresponding frames from each source data stream within a single packed frame according to a predetermined frame packing format. Several arrangement patterns are possible depending on the specific requirements and characteristics of the source data. In the side-by-side arrangement illustrated in FIG. 2, frame packing unit 106 positions the frame of the first source data in the left region of the packed source picture while the frame of the second source data occupies the right region. Alternatively, in the top-bottom arrangement shown in FIG. 3, frame packing unit 106 places the frame of the first source data in the upper portion of the packed source picture with the frame of the second source data positioned below it. FIG. 4 demonstrates a corner arrangement where frame packing unit 106 positions the frame of the first source data, typically the main video content, to occupy the majority of the packed source picture area while the frame of the second source data is positioned in one corner region. For scenarios involving three or more source data streams as shown in FIGS. 5-8, frame packing unit 106 employs more complex custom arrangements to accommodate the third source data and any additional sources.

The packing process performed by frame packing unit 106 may include alignment to coding block boundaries. Modern video codecs operate on specific block structures, such as coding tree units (CTUs) of 32×32 pixels in H.265/HEVC and H.266/VVC, macroblocks of 16×16 pixels in H.264/AVC, or superblocks in AV1, as noted in the annotations of FIG. 2. Frame packing unit 106 can align each source data region to these coding block boundaries to ensure efficient compression by video encoder 110. This alignment requirement often results in padding regions within the packed frame that do not contain active video content but ensure that each source data region begins and ends at appropriate block boundaries, as illustrated by the spacing visible in FIGS. 2-4 between the different source data regions.

Concurrent with the frame packing process, frame packing unit 106 generates packed information metadata that describes the organization of the packed source picture. This metadata includes a frame packing format identifier that specifies which arrangement pattern is being used (such as those shown in FIGS. 2, 3, or 4 , for two sources, or FIGS. 6, 7, or 8,for three sources), the original resolution of each source data stream, the original color format of each source data before conversion, the precise spatial coordinates defining each region within the packed frame, and the uniform color format adopted for the packed source data. This packed information can enable decoders to properly reconstruct the individual source data streams from the compressed bitstream and will be encoded into the video bitstream by video encoder 110 as Supplemental Enhancement Information (SEI) messages or equivalent metadata structures depending on the codec being used. The packed source data generated by frame packing unit 106 is then provided to video encoder 110 along with the packed information.

In step S906, distortion control unit 112 applies differentiated distortion control policies that treat different regions of the packed source picture according to their specific content characteristics and quality requirements. The distortion control process performed by distortion control unit 112 primarily operates through rate control mechanisms that regulate the quantization parameters (QP) applied to coding units during the video compression process executed by video encoder 110. By applying region-specific rate control strategies, distortion control unit 112 achieves optimal quality allocation among the different source data streams without necessitating an increase in overall bitrate, thereby maintaining bandwidth efficiency while maximizing perceptual quality where it matters most.

The first distortion control policy applied by distortion control unit 112 to the first region containing the first source data (as shown in the frame of the first source data depicted in FIGS. 2-4) typically determines quantization parameters based on a first bit-rate setting. When the first source data represents the main video content requiring high visual quality, the first distortion control policy allocates a larger portion of the available bitrate to this region. The quantization parameter values are dynamically adjusted by distortion control unit 112 frame by frame and even coding unit by coding unit to maintain consistent quality while adhering to the first bit-rate target. For particularly important areas within the first source data, such as regions of interest (ROI) illustrated in FIG. 2, even finer QP control may be applied by distortion control unit 112 to ensure these critical regions receive optimal quality. This QP information is communicated from distortion control unit 112 to video encoder 110 to guide the encoding process.

The second distortion control policy, applied by distortion control unit 112 to the second region containing the second source data (as shown in the frame of the second source data depicted in FIGS. 2-4), may employ different strategies depending on the nature of the content. In one approach, the second policy uses bit-rate based control similar to the first policy but with a different, typically lower, bit-rate setting appropriate for the content type. For example, depth maps or auxiliary segmentation information generally require less bitrate than main video content to achieve acceptable quality because these data types are often less perceptually critical or contain simpler patterns that compress more efficiently.

Alternatively, distortion control unit 112 may employ predetermined quantization parameter settings for the second distortion control policy instead of dynamic rate control. Under this approach, coding units in the second region may be encoded using an absolute QP value, meaning all blocks in that region use a fixed quantization parameter such as QP equals 35 regardless of content complexity. Another option is an offset-based approach where distortion control unit 112 calculates the QP for the second region relative to the QP values used in other regions. A more sophisticated variant employs a quantization parameter map such as a spatial mapping that defines specific QP values for different coding units within the second region, allowing for spatially varying quality within that region while still maintaining an overall lower bitrate allocation compared to the first region.

When more than two source data streams are packed together by frame packing unit 106, which combines three sources shown in FIGS. 6-8, distortion control unit 112 applies a separate tailored distortion control policy to each region. For instance, as illustrated in the three-source scenario of FIG. 5, the first region containing the frame of the first source data might use the first bit-rate setting with adaptive rate control to maintain high quality, the second region containing the frame of the second source data might employ the second bit-rate setting with its own adaptive rate control at a moderate quality level, and the third region containing the frame of the third source data (depth or other auxiliary data) might use predetermined QP settings for consistent, lower-bitrate encoding. This multi-policy approach implemented by distortion control unit 112 ensures that each type of content receives compression treatment appropriate to its perceptual importance and characteristics, leading to optimal overall quality within the available bitrate budget and avoiding the wasteful allocation of bits to content that does not benefit proportionally from increased bitrate. The distortion control information generated by distortion control unit 112 is provided to video encoder 110 to regulate the quantization process during encoding.

In step S908, video encoder 110 performs encoding of the packed source picture using a standard video codec such as H.264/AVC, H.265/HEVC, H.266/VVC, or AV1, while applying the distortion control policies established by distortion control unit 112 in the previous step. The encoding process performed by video encoder 110 employs all the standard techniques of modern video compression, including intra-frame prediction that exploits spatial redundancy within each frame, inter-frame motion compensation that identifies and encodes only the differences between successive frames, transform coding using techniques such as the Discrete Cosine Transform (DCT) or Discrete Sine Transform (DST) to convert spatial domain data into frequency domain coefficients, quantization of these transform coefficients using the region-specific QP values determined by distortion control unit 112, and entropy coding using methods such as Context-Adaptive Binary Arithmetic Coding (CABAC) or Context-Adaptive Variable-Length Coding (CAVLC) to achieve final compression of the quantized data.

An aspect of the encoding step performed by video encoder 110 is the proper embedding of the packed information metadata generated by frame packing unit 106 during the frame packing step. This metadata is encoded as supplementary information within the video bitstream using codec-specific mechanisms. In H.264, H.265, and H.266 codecs, this is typically accomplished through Supplemental Enhancement Information (SEI) messages, which are special syntax structures designed to carry metadata that is not essential for decoding the video pictures themselves but provides information about how the video data should be interpreted or displayed. In the AV1 codec, similar functionality is provided through metadata messages. Alternatively, some implementations of video encoder 110 may embed the packed information as custom syntax elements within the video parameter set or sequence parameter set, making it available to the decoder from the very beginning of the bitstream.

The inclusion of this metadata by video encoder 110 enables decoders to correctly unpack and reconstruct the individual source data streams from the composite packed frame. Without this information, a decoder would receive what appears to be a single, oddly-arranged video frame (as shown in the packed source data frames of FIGS. 2-4 or FIGS. 6-8) and would have no way of knowing that it actually contains multiple logically separate source data streams arranged in a specific pattern. The metadata provides all the necessary information for the decoder to identify the boundaries of each region (the first region, second region, and potentially third region as shown in the various figures), understand the original color format and resolution of each source, and properly extract and process each source data stream independently.

The result of encoding the packed source picture is a video bitstream with the compressed video data representing the packed source picture, the packed information metadata describing how the sources are organized, and the standard codec headers and parameters required for proper decoding. This bitstream can be stored, transmitted, or processed using existing video infrastructure designed for the chosen codec standard, requiring no modifications to decoders beyond the ability to interpret and act upon the packed information metadata.

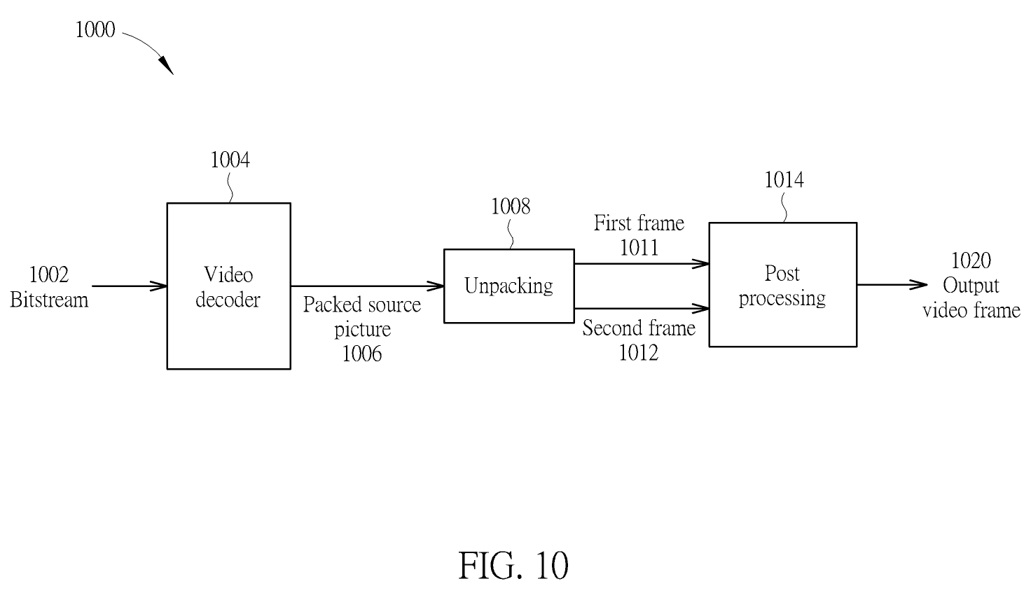

FIG. 10 depicts a schematic block diagram illustrating a video processing system 1000 according to an embodiment of the present disclosure. The video processing system 1000 is configured to decode the video bitstream 1002 with unpacking to generate an output video frame 1020. The process initiates when the video bitstream 1002, which comprises encoded and compressed video data (such as HEVC, H.264, or VVC compliant streams), is received by the video decoder 1004. The video decoder 1004 performs inverse encoding operations—including entropy decoding, inverse quantization, and inverse transformation—to reconstruct the pixel data. The output of this decoding stage is the packed source picture 1006. This packed source picture 1006 is a composite image frame where multiple constituent views (e.g., stereoscopic left and right views) or temporal frames are spatially multiplexed into a single frame buffer (e.g., in a side-by-side or top-and-bottom arrangement).

Subsequently, the packed source picture 1006 is transmitted to the unpacking unit 1008. The unpacking unit 1008 is logic configured to parse the spatial arrangement of the composite frame, potentially utilizing metadata or Supplemental Enhancement Information (SEI) messages found in the bitstream to determine the specific packing format used. Based on this format, the unpacking unit 108 separates the data by cropping or extracting specific regions of the packed picture. This separation results in the generation of two distinct, independent image components: a first frame 1011 and a second frame 1012. These frames now exist as separate entities rather than being combined within a single spatial grid.

Following separation, both the first frame 1011 and the second frame 1012 are forwarded to the post-processing unit 1014. The post-processing unit 1014 is responsible for conditioning the unpacked frames for final output or display. Depending on the application requirements, the post-processing unit 1014 may perform various operations on the separated frames. For example, if the original frame packing process involved spatial resampling or rescaling to fit multiple source data into the packed frame, the post-processing unit 1014 may apply upscaling or interpolation filters to restore the frames to their original resolutions. Additionally, the post-processing unit 1014 may perform color space conversion (such as YUV to RGB for display purposes), apply artifact reduction or denoising filters, perform temporal synchronization of the frames, or combine the multiple source data streams for composite rendering. In certain applications, the post-processing unit 1014 may use the second frame 1012 (such as depth information or segmentation data) to enhance or modify the first frame 1011 (the main video content), for example by applying depth-based blur effects, skin tone adjustments, or other computational photography techniques. The result is the output video frame 1020, which may represent a single processed frame ready for display, storage, or further downstream processing.

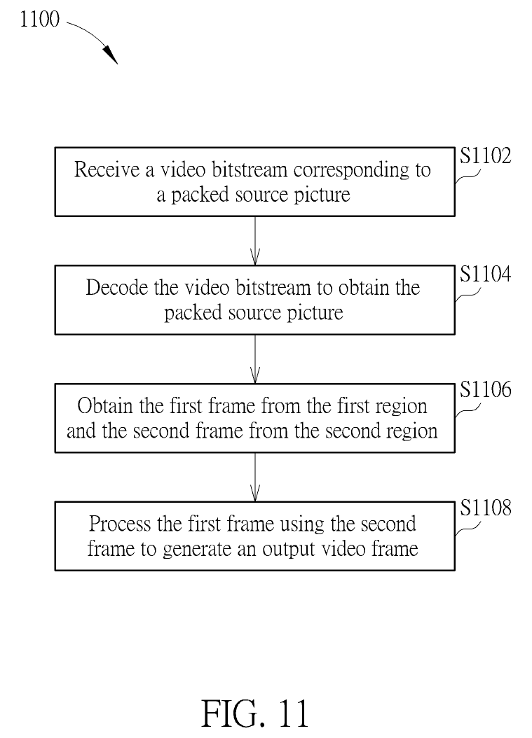

FIG. 11 depicts a flow diagram of method 1100 for video decoding in a video system that implements unpacking and reconstruction of multiple source data streams from a single compressed video bitstream. The method 1000 represents the complementary decoding process to the method 900 for encoding and may be implemented by the video processing system 1000 of FIG. 10. The method 1100 includes the following steps:

S1102: Receive a video bitstream corresponding to a packed source picture;

S1104: Decode the video bitstream to obtain the packed source picture, wherein the packed source picture comprises a first region including a first frame and a second region including a second frame;

S1106: Obtain the first frame from the first region and the second frame from the second region; and

S1108: Process the first frame using the second frame to generate an output video frame.

In step S1102 of method 1100, video processing system 1000 receives video bitstream 1002, which contains the compressed representation of a packed source picture that was generated by the encoding process described in method 900. This video bitstream 1002 could be produced by video encoder 110 of video processing system 100 (FIG. 1) or video encoder 510 of video processing system 500 (FIG. 5) and can include the compressed video data and packed information metadata. The packed information, typically encoded as Supplemental Enhancement Information (SEI) messages in H.264/H.265/H.266 codecs or as metadata messages in AV1, describes the organization of the packed source picture, including the frame packing format used (such as the side-by-side arrangement of FIG. 2, the top-bottom arrangement of FIG. 3, the corner arrangement of FIG. 4, or the three-source arrangements shown in FIGS. 6-8), the original resolution and color format of each source data stream, and the spatial coordinates defining each region within the packed frame. Video processing system 1000 receives this bitstream 1002 through various means such as file storage, network transmission, or streaming protocols, and prepares it for decoding by video decoder 1004.

In step S1104, video decoder 1004 performs the decoding process to reconstruct packed source picture 1006 from the compressed video bitstream 1002. Video decoder 1004 operates according to the same video coding standard that was used during encoding (such as H.264/AVC, H.265/HEVC, H.266/VVC, or AV1) and applies standard decoding techniques including entropy decoding to recover quantized transform coefficients from the bitstream, inverse quantization using the quantization parameters that were applied during encoding (which may differ between regions due to the differentiated distortion control policies applied by distortion control unit 112 during encoding), inverse transform using techniques such as Inverse Discrete Cosine Transform (IDCT) or Inverse Discrete Sine Transform (IDST) to convert frequency domain coefficients back to spatial domain pixel values, and motion compensation and intra prediction to fully reconstruct the video frames.

During the decoding process, video decoder 1004 extracts and parses the packed information metadata that was embedded in video bitstream 1002. This metadata provides video decoder 1004 and subsequent processing stages with essential information about how the packed source picture 1006 is organized. Specifically, the packed information indicates that packed source picture 1006 comprises multiple distinct regions, including at least a first region containing a first frame (corresponding to the first source data that was encoded, such as main video content) and a second region containing a second frame (corresponding to the second source data that was encoded, such as depth information, segmentation data, or other auxiliary information). The packed information also specifies the precise boundaries of these regions, their original color formats before the uniform conversion performed during encoding, and their original resolutions.

The reconstructed packed source picture 1006 output by video decoder 1004 maintains the same spatial organization that was created by frame packing unit 106 during encoding, with the first frame positioned in the first region and the second frame positioned in the second region. For example, if the encoding process used the side-by-side arrangement of FIG. 2, the reconstructed packed source picture 1006 will have the first frame in the left region and the second frame in the right region. If the top-bottom arrangement of FIG. 3 was used, the first frame will be in the upper portion and the second frame in the lower portion. Video decoder 1004 provides the reconstructed packed source picture 1006 along with the extracted packed information to unpacking unit 1008 for subsequent separation of the individual source data streams.

In step S1106, unpacking unit 1008 performs the spatial separation and extraction of the individual source frames from packed source picture 1006. Using the packed information metadata extracted by video decoder 1004, unpacking unit 1008 identifies the precise boundaries of each region within packed source picture 1006 and extracts the corresponding frame data. Specifically, unpacking unit 1008 extracts first frame 1011 from the first region of packed source picture 1006, where the first region corresponds to the area that contained the frame of the first source data 202 (FIG. 2), 302 (FIG. 3), or 402 (FIG. 4) during encoding. Similarly, unpacking unit 1008 extracts second frame 1012 from the second region of packed source picture 1006, where the second region corresponds to the area that contained the frame of the second source data 204 (FIG. 2), 304 (FIG. 3), or 404 (FIG. 4) during encoding.

The unpacking process performed by unpacking unit 1008 is essentially the inverse of the packing process performed by frame packing unit 106 during encoding. While frame packing unit 106 combined multiple source frames into a single composite frame, unpacking unit 1008 separates the composite frame back into its constituent source frames. This separation is performed using the spatial coordinate information provided in the packed information metadata, which specifies exactly which pixels or coding blocks belong to which source data stream. For scenarios where three or more source data streams were packed together (as shown in FIGS. 6-8 for the three-source embodiment), unpacking unit 1008 can similarly extract all individual frames from their respective regions within the packed source picture.

After extraction, unpacking unit 1008 may also perform color format conversion if necessary. Recall that during encoding, frame packing unit 106 converted all source data to a uniform color format before packing. The packed information metadata includes the original color format of each source data stream before this conversion. Therefore, unpacking unit 1008 can convert first frame 1011 and second frame 1012 back to their original color formats if required by the downstream application. For example, if the first source data was originally in YUV 4:2:0 format and the second source data was originally in Y-only format, but both were converted to YUV 4:2:2 for packing, unpacking unit 1008 can restore them to their original formats. Unpacking unit 1008 then provides first frame 1011 and second frame 1012 to post-processing unit 1014 for further conditioning and output generation.

In step S1108, post-processing unit 1014 processes the unpacked frames to generate output video frame 1020. This processing step can be flexible and application-dependent, allowing video processing system 1000 to support various use cases and output requirements. Post-processing unit 1014 receives both first frame 1011 and second frame 1012 from unpacking unit 1008 and performs processing operations that utilize the information from second frame 1012 to enhance, modify, or supplement first frame 1011, ultimately producing output video frame 1020 suitable for display, storage, or further downstream processing.

The specific processing operations performed by post-processing unit 1014 depend on the nature of the source data and the intended application. In applications where the first source data represents main video content and the second source data represents auxiliary information such as depth maps, post-processing unit 1014 may use the depth information in second frame 1012 to apply depth-based visual effects to first frame 1011. For example, post-processing unit 1014 can create bokeh or background blur effects by applying varying degrees of blur to different regions of first frame 1011 based on their depth values indicated in second frame 1012, simulating the shallow depth of field characteristic of professional cameras.

When second frame 1012 contains segmentation information such as skin tone maps or object boundaries, post-processing unit 1014 can use this information to apply selective adjustments to first frame 1011. For instance, post-processing unit 1014 may apply skin smoothing or beauty enhancement filters only to regions identified as skin in the segmentation map of second frame 1012, or may apply different color grading or exposure adjustments to foreground and background regions as delineated by the segmentation data. This allows for sophisticated, content-aware image processing that would be difficult or computationally expensive to perform in real-time without the pre-computed auxiliary data provided by second frame 1012.

In addition to content-based processing, post-processing unit 1014 may perform various restoration and conditioning operations. If the frame packing process performed by frame packing unit 106 involved spatial resampling or rescaling to fit multiple source data into the packed frame efficiently, post-processing unit 1014 may apply upscaling or interpolation filters to restore first frame 1011 and second frame 1012 to their original resolutions as specified in the packed information metadata. Post-processing unit 1014 may also perform color space conversion, such as converting from YUV to RGB for display on consumer devices, apply deblocking or artifact reduction filters to improve visual quality, or perform temporal synchronization to ensure proper alignment when multiple frames are processed in sequence for video playback.

For certain applications, post-processing unit 1014 may combine or composite the multiple source frames in specific ways. For example, in augmented reality or mixed reality applications, first frame 1011 might contain the main scene while second frame 1012 contains overlay information or virtual objects, which post-processing unit 1014 composites together to create output video frame 1020. In multi-view or stereoscopic applications, first frame 1011 and second frame 1012 might represent left and right eye views, which post-processing unit 1014 can process and combine for 3D display systems.

The flexibility of post-processing unit 1014 allows video processing system 1000 to support diverse applications while leveraging the efficient multi-source compression achieved by video processing system 100 and method 900. By packing multiple related source data streams together for compression and transmission, then unpacking and utilizing them in combination during playback, the overall system achieves both power efficiency during encoding (by reducing the number of encoder invocations) and functional richness during decoding (by providing multiple information streams that enable advanced processing). The output video frame 1020 produced by post-processing unit 1014 can be sent to a display device, saved to storage, or forwarded to additional processing stages as required by the application.

On the encoding side, by consolidating multiple synchronized source data streams into a single packed frame for compression, the method reduces power consumption by minimizing the number of encoder invocations, which is particularly valuable in battery-powered devices such as smartphones. The differentiated distortion control policies enable optimal quality allocation across different content types, ensuring that main video content receives high quality while auxiliary data such as depth maps or segmentation information are compressed at appropriate levels without wasting bitrate. This results in better overall quality within a given bandwidth budget compared to uniform compression of all sources. On the decoding side, the method efficiently reconstructs the individual source streams from the bitstream and enables sophisticated applications through post processing, such as depth-based blur effects, segmentation-based enhancement, and computational photography, all while maintaining full compatibility with standard video codecs. The combined encoding and decoding framework thus achieves power efficiency, bandwidth efficiency, quality optimization, and application flexibility simultaneously, making it well-suited for modern multi-source video applications.

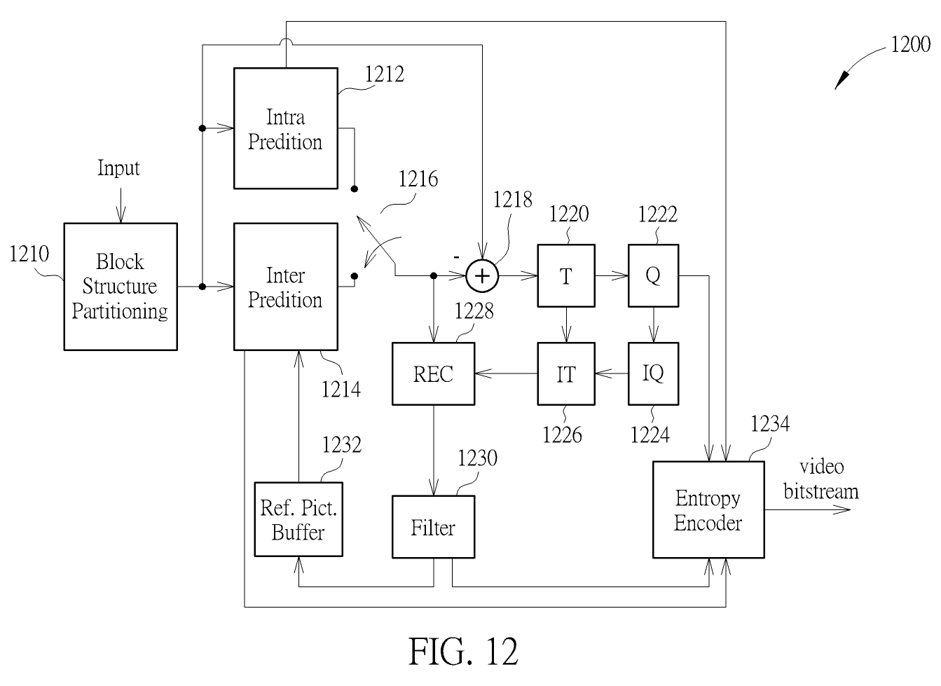

FIG. 12 depicts a video encoder 1200 which may be implemented by the video processing system 100 (or video processing system 500) to perform the encoding operations described in the above embodiments. The video encoder 1200 receives input video frames and compresses them into a video bitstream using a combination of prediction, transformation, quantization, and entropy coding techniques.

The main component responsible for video block processing is the block structure partitioning module 1210, which divides the input video into non-overlapping blocks and further partitions each block using a recursive structure into smaller leaf blocks. The block structure partitioning module 1210 evaluates various splitting patterns, such as quadtree, binary tree, or ternary tree partitioning, to determine the optimal block structure for encoding. The module checks if predefined splitting types are allowed based on constraints related to pipeline units, which are non-overlapping units in the current video picture designed for pipeline processing and parallel hardware execution. For each block, the allowed splitting type that optimizes the rate-distortion performance is selected based on a cost function that balances compression efficiency and visual quality. The corresponding partitioning information is signaled in the video bitstream to enable decoders to reconstruct the same block structure during decoding.

Each leaf block in the current video picture is then processed by either the intra prediction module 1212 or the inter prediction module 1214, depending on whether spatial or temporal redundancy is being exploited. The intra prediction module 1212 generates intra predictors for the current leaf block by using reconstructed pixel data from the same picture, typically from neighboring blocks that have already been encoded and reconstructed. The intra prediction module 1212 may employ various directional prediction modes, planar prediction, or DC prediction to create a prediction signal that closely matches the current block. Alternatively, the inter prediction module 1214 performs motion estimation and motion compensation to provide inter predictors based on previously encoded reference pictures stored in the reference picture buffer 1232. The inter prediction module 1214 searches for matching blocks in one or more reference pictures, determines motion vectors that describe the spatial displacement, and generates prediction signals by copying and interpolating pixel values from the reference pictures. The choice between intra and inter prediction for each block is made based on rate-distortion optimization to achieve the best compression efficiency.

After prediction, the residual signal, which represents the prediction errors or differences between the original block and the predicted block, is then processed by the transform (T) module 1220 and quantization (Q) module 1222. The transform module 1220 applies a mathematical transform, such as the Discrete Cosine Transform (DCT), Discrete Sine Transform (DST), or other transform types, to convert the spatial domain residual signal into frequency domain coefficients. This transformation concentrates the signal energy into a smaller number of coefficients, making the data more amenable to compression. The quantization module 1222 then quantizes these transform coefficients by dividing them by quantization step sizes and rounding to integer values, which reduces the precision of the coefficients and achieves significant data compression. The quantization step sizes are controlled by quantization parameters (QP) that may vary across different blocks or regions based on the distortion control policies, such as those applied by the distortion control unit in the multi-source video compression system described in earlier embodiments. The quantized coefficients are then encoded into the compressed video bitstream by the entropy encoder 1234, which applies variable-length coding or arithmetic coding techniques to further compress the data by exploiting statistical redundancies.

To enable subsequent inter prediction, the video encoder 1200 reconstructs the encoded video internally. The quantized transform coefficients are processed by the inverse quantization (IQ) module 1224, which reverses the quantization operation by multiplying the coefficients by the appropriate quantization step sizes to recover approximations of the original transform coefficients. The inverse transform (IT) module 1226 then applies the inverse transform operation to convert the frequency domain coefficients back to the spatial domain, recovering an approximation of the residual signal. The reconstruction (REC) module 1228 produces the reconstructed video block by adding the recovered residual signal to the prediction signal that was generated by either the intra prediction module 1212 or the inter prediction module 1214. This reconstructed block approximates the original input block but with some loss of information due to the quantization process.

The in-loop processing filter 1230 enhances the reconstructed picture quality by applying various filtering operations before the reconstructed picture is stored in the reference picture buffer 1232 for later inter prediction. The in-loop processing filter 1230 may include a deblocking filter that reduces blocking artifacts at block boundaries caused by independent block processing, a sample adaptive offset (SAO) filter that reduces ringing artifacts and improves overall visual quality, and an adaptive loop filter (ALF) that applies Wiener-based filtering to minimize the mean square error between the reconstructed picture and the original picture. These filtered reconstructed pictures are stored in the reference picture buffer 1232, where they serve as reference pictures for encoding subsequent frames using inter prediction. By maintaining high-quality reference pictures, the video encoder 1200 can achieve better prediction accuracy and overall compression efficiency throughout the video sequence.

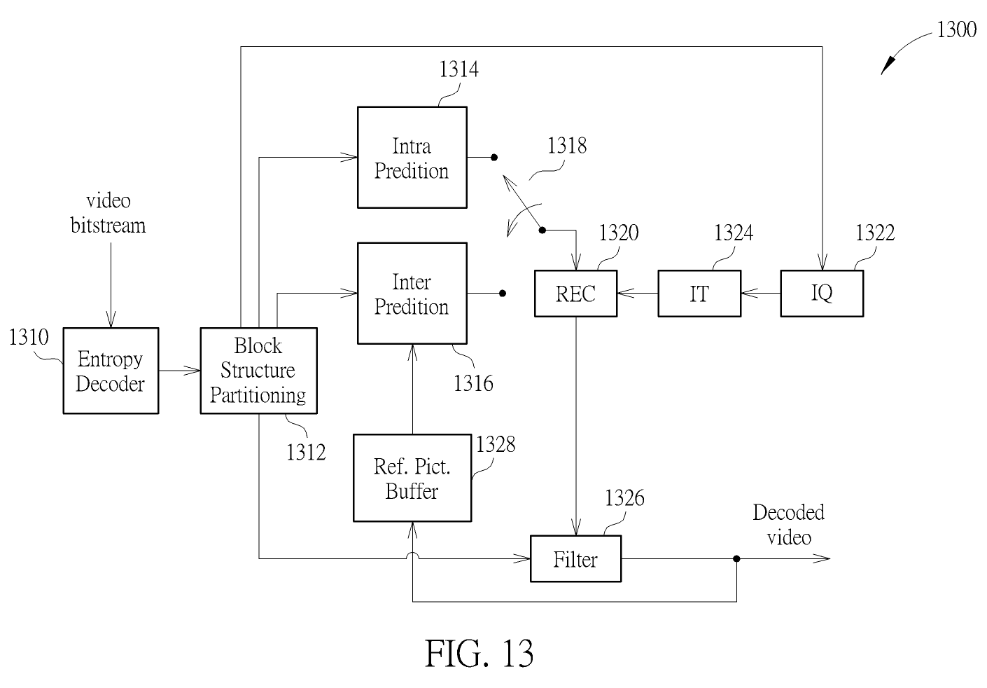

FIG. 13 depicts a video decoder 1300 which may be implemented by the video processing system 1000 to perform the decoding operations described in the above embodiments. The video decoder 1300 receives a compressed video bitstream and decompresses it to reconstruct video frames using a combination of entropy decoding, inverse quantization, inverse transformation, and prediction techniques.

The input compressed video bitstream is first processed by the entropy decoder 1310, which parses and recovers the quantized transform coefficients representing the residual signal, along with other system information such as prediction modes, motion vectors, partitioning structures, and control parameters. The entropy decoder 1310 applies variable-length decoding or arithmetic decoding techniques to reverse the entropy coding performed by the encoder, extracting the encoded syntax elements from the bitstream.

The block structure partitioning module 1312 then determines the block partitioning structure for each block in the video picture based on the partitioning information signaled in the bitstream. The block structure partitioning module 1312 reconstructs the same hierarchical block structure that was determined by the encoder's block structure partitioning module 1210, following the same constraints related to quadtree, binary tree, or ternary tree partitioning and pipeline units. This ensures that the decoder processes the video using the identical block boundaries and leaf block divisions as the encoder.

Each leaf block is decoded using either the intra prediction module 1314 or the inter prediction module 1316, depending on the prediction mode information signaled in the bitstream. The intra prediction module 1314 generates intra predictors for the current leaf block by using reconstructed pixel data from the same picture, applying the same directional prediction modes, planar prediction, or DC prediction that were used during encoding. The inter prediction module 1316 performs motion compensation to provide inter predictors based on previously decoded reference pictures stored in the reference picture buffer 1328. The inter prediction module 1316 uses the decoded motion vectors to locate matching blocks in the reference pictures and generates prediction signals by copying and interpolating pixel values. The appropriate predictor is selected by switch 1318 based on the decoded mode information extracted from the bitstream.

The quantized transform coefficients recovered by the entropy decoder 1310 are processed through a reconstruction path. The inverse quantization (IQ) module 1322 reverses the quantization operation by multiplying the quantized coefficients by the appropriate quantization step sizes to recover approximations of the original transform coefficients. The quantization step sizes correspond to the quantization parameters (QP) that were applied during encoding, which may vary across different blocks or regions based on the distortion control policies. The inverse transform (IT) module 1324 then applies the inverse transform operation, such as Inverse Discrete Cosine Transform (IDCT) or Inverse Discrete Sine Transform (IDST), to convert the frequency domain coefficients back to the spatial domain, recovering an approximation of the residual signal.

The reconstruction (REC) module 1320 produces the reconstructed video block by adding the recovered residual signal to the prediction signal that was selected by switch 1318 from either the intra prediction module 1314 or the inter prediction module 1316. This reconstructed block represents the decoded video content but may contain some artifacts due to the lossy compression process.

The in-loop processing filter 1326 enhances the reconstructed picture quality by applying the same filtering operations that were used in the encoder's reconstruction loop. The in-loop processing filter 1326 may include a deblocking filter to reduce blocking artifacts at block boundaries, a sample adaptive offset (SAO) filter to reduce ringing artifacts and improve visual quality, and an adaptive loop filter (ALF) to minimize reconstruction errors. The filtered reconstructed video is the final decoded output and, if the current picture is designated as a reference picture, it is also stored in the reference picture buffer 1328 for use in decoding subsequent frames through inter prediction. By maintaining the same reference pictures as the encoder, the video decoder 1300 can accurately reconstruct the prediction signals and achieve proper decoding of the entire video sequence.

The terminology employed in the description of the various embodiments herein is intended for the purpose of describing particular embodiments and should not be construed as limiting. In the context of this description and the appended claims, the singular forms "a", "an", and "the" are intended to encompass plural forms as well, unless the context clearly indicates otherwise.

It should be understood that the term "and/or" as used herein is intended to encompass any and all possible combinations of one or more of the associated listed items. Furthermore, it should be noted that the terms "includes," "including," "comprises," and/or "comprising," when used in this specification, indicate the presence of stated features, integers, steps, operations, elements, and/or components, but do not exclude the presence or addition of one or more other features, integers, steps, operations, elements, components, and/or groups thereof.

Unless specifically stated otherwise, the term "some" refers to one or more. Various combinations using "at least one of" or "one or more of" followed by a list (e.g., A, B, or C) should be interpreted to include any combination of the listed items, including individual items and multiple items.

In the context of this disclosure, the terms "coupled," "connected," "connecting," "electrically connected," and similar expressions are used interchangeably to broadly denote the state of being electrically or electronically connected. Furthermore, an entity is deemed to be in "communication" with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

The use of ordinal designators like "first," "second," and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art.

As may be used throughout this specification and the appended claims, terms of approximation and degree such as "substantially," "approximately," "generally," "essentially," "nearly," "about," and similar expressions are used to account for variations in precision, manufacturing tolerances, measurement accuracy, environmental conditions, and inherent material properties that may affect the described features or characteristics. Such variations may range from ±20% in broader applications to progressively tighter tolerances of ±10%, ±5%, ±3%, ±2%, ±1%, or ±0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, Random Access Memory (RAM), Read Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Some embodiments may involve computers on a distributed computing network, such as a network with multiple clients and/or servers. In such embodiments, clients may run software implementing client-side portions of the described systems and methods, while servers handle requests from these clients. Communication between clients and servers may occur via one or more electronic networks, which may include the Internet, wide area networks, mobile telephone networks, wireless networks (e.g., Wi-Fi, 5G), or local area networks, implemented using any known network protocols.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of video encoding in a video system, comprising:
receiving a first source data and a second source data for a same packed source data;
generating a packed source picture by arranging a first frame corresponding to the first source data into a first region of the packed source picture and a second frame corresponding to the second source data into a second region of the packed source picture;
applying a distortion control process to the packed source picture, wherein the distortion control process utilizes a first distortion control policy for the first region and a second distortion control policy for the second region; and
encoding the packed source picture based on the distortion control process.

2. The method of claim 1, wherein the first distortion control policy determines a quantization parameter for each coding unit within the first region according to a bit-rate setting of a rate control process.

3. The method of claim 2, wherein the second distortion control policy applies a predetermined quantization parameter setting to the second region.

4. The method of claim 3, wherein the predetermined quantization parameter setting comprises an absolute quantization parameter value, a fixed offset value relative to a quantization parameter of the first region, or a quantization parameter map indicating quantization parameters for a plurality of coding units within the second region.

5. The method of claim 1, further comprising converting a color format of at least one of the first source data or the second source data to a uniform color format prior to generating the packed source picture, wherein the packed source picture is generated in the uniform color format.

6. The method of claim 1, wherein a boundary between the first region and the second region within the packed source picture is aligned with a boundary of a coding block unit used in encoding the packed source picture.

7. The method of claim 1, further comprising:
receiving a third source data for the same packed source data; and
arranging a third frame corresponding to the third source data into a third region of the packed source picture;
wherein the distortion control process further uses a third distortion control policy for the third region.

8. The method of claim 1, wherein the first source data comprises video content, and the second source data comprises depth information or segmentation information associated with the video content.

9. The method of claim 1, further comprising encoding packed information into the video bitstream as supplementary information, wherein the packed information indicates a resolution and a color format for each source data in the packed source picture.

10. A method of video decoding in a video system, comprising:
receiving a video bitstream corresponding to a packed source picture;
decoding the video bitstream to obtain the packed source picture, wherein the packed source picture comprises a first region including a first frame and a second region including a second frame;
obtaining the first frame from the first region and the second frame from the second region; and
processing the first frame using the second frame to generate an output video frame.

11. The method of claim 10, further comprising:
receiving packed information associated with the video bitstream, wherein the packed information indicates a resolution and a location of the first frame and the second frame within the packed source picture; and determining the first region and the second region based on the packed information.

12. The method of claim 10, wherein the packed information is decoded from a Supplemental Enhancement Information (SEI) message within the video bitstream.

13. The method of claim 10, wherein the first frame comprises main video content, and the second frame comprises depth information or segmentation information associated with the main video content.

14. The method of claim 13, wherein processing the first frame using the second frame comprises applying a visual effect to the main video content based on the depth information or the segmentation information to generate the output video frame.

15. The method of claim 14, wherein the visual effect comprises a depth-of-field effect or a skin enhancement effect.

16. The method of claim 10, wherein:
the packed source picture is in a uniform color format comprising a plurality of color channels; and
the second region of the packed source picture comprises padding values in specific color channels that are present in the uniform color format but absent in an original source format of the second frame.

17. The method of claim 10, wherein a boundary between the first region and the second region is aligned with a boundary of a coding block unit of the packed source picture.

18. The method of claim 10, wherein:
the packed source picture further comprises a third region having a third frame; and
processing the first frame further comprises using the third frame to generate the output video frame.

19. An apparatus for video encoding, comprising: one or more processors configured to:
receive a first source data and a second source data for a same packed source data;
generate a packed source picture by arranging a first frame corresponding to the first source data into a first region of the packed source picture and a second frame corresponding to the second source data into a second region of the packed source picture;
apply a distortion control process to the packed source picture; and
encode the packed source picture into a video bitstream based on the distortion control process;
wherein the distortion control process uses a first distortion control policy for the first region and a second distortion control policy for the second region.

20. The apparatus of claim 19, wherein the first distortion control policy determines a quantization parameter for each coding unit within the first region according to a bit-rate setting of a rate control process, and the second distortion control policy applies a predetermined quantization parameter setting to the second region.
